(19) United States
(12) Patent Application Publication
(10) Pub. No.: US 2025/0209535 A1
(43) Pub. Date: Jun. 26, 2025

(54) METHOD FOR OPTIMIZED DECISION RECOMMENDATION FOR OPERATIONS IN ASSET RECOVERY

(71) Applicant: Hitachi America, Ltd., Santa Clara, CA (US)

(72) Inventors: Dipanjan GHOSH, Santa Clara, CA (US); Manish GUPTA, Santa Clara, CA (US); Chandrasekar VENKATRAMAN, Santa Clara, CA (US); Chetan GUPTA, Santa Clara, CA (US); Umeshwar DAYAL, Santa Clara, CA (US)

(21) Appl. No.: 18/851,905

(22) PCT Filed: Mar. 28, 2022
(86) PCT No.: PCT/US2022/022195

§ 371 Date: Sep. 27, 2024

(51) Int. Cl. G06Q 40/06; G06Q 10/30

(52) U.S. Cl. CPC G06Q 40/06; G06Q 10/30

(57) ABSTRACT

A method for providing one or more recommendations regarding disposition of one or more asset classes is disclosed. The method may include accessing information regarding a first plurality of unintegrated analytics models for a value of assets in one or more asset classes to a plurality of stakeholders. The method may further include training, using an integrated training methodology, a plurality of integrated analytics models to maximize a value of an asset in the one or more asset classes for the plurality of stakeholders. The method may also include generating, for each of a set of stakeholders in the plurality of stakeholders, a recommendation regarding a disposition of a particular asset in the one or more asset classes based on the plurality of integrated models trained to maximize the value of the particular asset.

### BACKGROUND

### Field

The present disclosure is generally directed to asset disposition recommendation.

### Related Art

An approach to economic development with the aim to eliminate waste and incorporate circularity in use of resources is sometimes referred to as a Circular Economy (CE) approach with the underlying economic system referred to as the CE. This approach introduces opportunities for businesses to transform linear economy inefficiencies into business value. A CE approach involves considering a complex network of stakeholders for whom value is to be maximized. Value in the case of CE, in some aspects, involves economic, social, and environmental values represented by different key performance indicators (KPI). Various business models for CE have been identified such as circular supply chain, sharing platforms, product as a service, product life extension, resource recovery, and recycling. In some aspects, these business models are not mutually exclusive and generate maximum value when combined.

Currently in the CE value chain, various stakeholders make decisions based on siloed systems and data. This can lead to sub-optimal value creation as stakeholders rarely get to observe and understand the impact of decision making by other stakeholders. In short, the current suite of systems fails to leverage the information from the network of stakeholders and their operational data. Based on this there is a need for a digital platform that aggregates data and recommends decisions to each stakeholder with the goal of optimizing their CE value(s)-economic, social, and environmental.

### SUMMARY

Example implementations described herein include an innovative method. The method may include accessing information regarding a first plurality of unintegrated analytics models for a value of assets in one or more asset classes to a plurality of stakeholders. The method may further include training, using an integrated training methodology, a plurality of integrated analytics models to maximize a value of an asset in the one or more asset classes for the plurality of stakeholders. The method may also include generating, for each of a set of stakeholders in the plurality of stakeholders, a recommendation regarding a disposition of a particular asset in the one or more asset classes based on the plurality of integrated models trained to maximize the value of the particular asset.

Example implementations described herein include an innovative computer-readable medium storing computer executable code. The computer executable code may include instructions for accessing information regarding a first plurality of unintegrated analytics models for a value of assets in one or more asset classes to a plurality of stakeholders. The computer executable code may also include instructions for training, using an integrated training methodology, a plurality of integrated analytics models to maximize a value of an asset in the one or more asset classes for the plurality of stakeholders. The computer executable code may further include instructions generating, for each of a set of stakeholders in the plurality of stakeholders, a recommendation regarding a disposition of a particular asset in the one or more asset classes based on the plurality of integrated models trained to maximize the value of the particular asset.

Example implementations described herein include an innovative apparatus. The apparatus may include a memory and at least one processor configured to access information regarding a first plurality of unintegrated analytics models for a value of assets in one or more asset classes to a plurality of stakeholders. The at least one processor may also be configured to train, using an integrated training methodology, a plurality of integrated analytics models to maximize a value of an asset in the one or more asset classes for the plurality of stakeholders. The at least one processor may further be configured to generate, for each of a set of stakeholders in the plurality of stakeholders, a recommendation regarding a disposition of a particular asset in the one or more asset classes based on the plurality of integrated models trained to maximize the value of the particular asset.

### BRIEF DESCRIPTION OF DRAWINGS

FIG. 1 is a diagram illustrating a basic concept of a circular economy in accordance with some aspects of the disclosure.

FIG. 2 is a diagram illustrating an abstracted interaction between the stakeholders in the asset recovery decision problem.

FIG. 3 is a diagram illustrating a set of possible interactions in an asset recovery value chain for a decision recommendation problem modelled as a value maximization optimization problem.

FIG. 4 is a diagram illustrating an example of a simplified version of a set of models (e.g., a value chain) depicted in FIG. 3.

FIG. 5 is a diagram illustrating a set of machine-trained models corresponding to the models depicted in FIG. 4.

FIG. 6 is a diagram of the trained models that may be used for generating a set of decision recommendations for the stakeholders.

FIG. 7 is a flow diagram illustrating a method for one or more recommendations regarding disposition of an asset in one or more asset classes.

FIG. 8 is a flow diagram illustrating a method for one or more recommendations regarding disposition of an asset in one or more asset classes.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between FIGS. are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this disclosure, an apparatus and method are presented that provide one or more recommendations regarding disposition of one or more asset classes. Example implementations described herein include an innovative data-driven machine learning method and apparatus that recommend an optimum decision to each stakeholder in a CE. The method provides model training and model inference, i.e., using a trained set of models to provide a set of recommendations to a set of stakeholders. In some aspects, during model training, the method develops a set of models (e.g., defines the models in the sets of models and performs machine-training) using historical data to recommend decisions. During model inference the trained set of models may be used to recommend a decision based on current input data. In some aspects, as discussed below, the set of models consists of various sub-models addressing a problem in the asset recovery value chain. Thus, this cluster of machine learning models work collectively to recommend optimum decisions to each stakeholder. In some aspects, the recommendations relate to product-life extension and resource recovery business models. The combined business model (e.g., the set of models), in some aspects, may be referred to as an asset recovery model. Further, asset recovery, in some aspects, includes various operations including repair, reuse, remanufacturing, etc.

Example implementations described herein include an innovative method. The method may include accessing information regarding a first plurality of unintegrated analytics models for a value of assets in one or more asset classes to a plurality of stakeholders. The method may further include training, using an integrated training methodology, a plurality of integrated analytics models to maximize a value of an asset in the one or more asset classes for the plurality of stakeholders. The method may also include generating, for each of a set of stakeholders in the plurality of stakeholders, a recommendation regarding a disposition of a particular asset in the one or more asset classes based on the plurality of integrated models trained to maximize the value of the particular asset.

A solution presented herein produces optimized decision recommendations for multiple stakeholders in the asset recovery value chain. For example, asset sellers may get recommendations to sell or not sell their asset and a price at which to sell if they choose to. Another example may include recommending to an asset recovery operator to either to buy an asset for asset recovery based on asset supply forecasting, demand forecasting, and CE targets. The method addresses producing optimum decisions to stakeholders by leveraging various information and possible decisions from other stakeholders and processes in the asset recovery value chain.

Described herein is a system that generates machine learning models to recommend decisions for all stakeholders in an asset recovery value chain in relation to a CE. The asset recovery process flow may include multiple actors or stakeholders in the asset recovery value-chain each trying to maximize their value. These value maximization objectives can be conflicting in nature. Accordingly, a data-driven and analytics-based decision optimization method is discussed herein. The method, in some aspects, recommends appropriate incentives to different stakeholders based on the state of the asset being recovered, current market conditions and preferences of the stakeholders.

The method, in some aspects, includes multiple components for which data-driven analytics play a key role for estimation. For example, a first component may include estimating the state of an asset, e.g., calculating a remaining-useful-life (RUL). To calculate the RUL, in some aspects, the system may use a regression model. For the discussion below, the following set of terms may be used to describe different assets, and stakeholders. A “core” may refer to a previously sold, worn-out, or non-functional product or part, intended for the remanufacturing process. A core, in some aspects, is not waste or scrap and is not intended to be reused before remanufacturing. The term “asset owner” may refer to an entity which has used an asset/core and is ready to sell it (e.g., dispose of the asset/core) to receive an incentive (e.g., a monetary incentive). A “recovery operator” may refer to an entity that processes the core by reusing/repair/remanufacturing cores and making the reused/repaired/remanufactured core available for purchase. A “post-recovery asset buyer” may refer to an entity that is interested in buying a recovered asset/core. Finally, a “reverse logistics provider” may refer to an entity that handles cores for remanufacturing to avoid damage, preserve value, and transport the core from one entity to another.

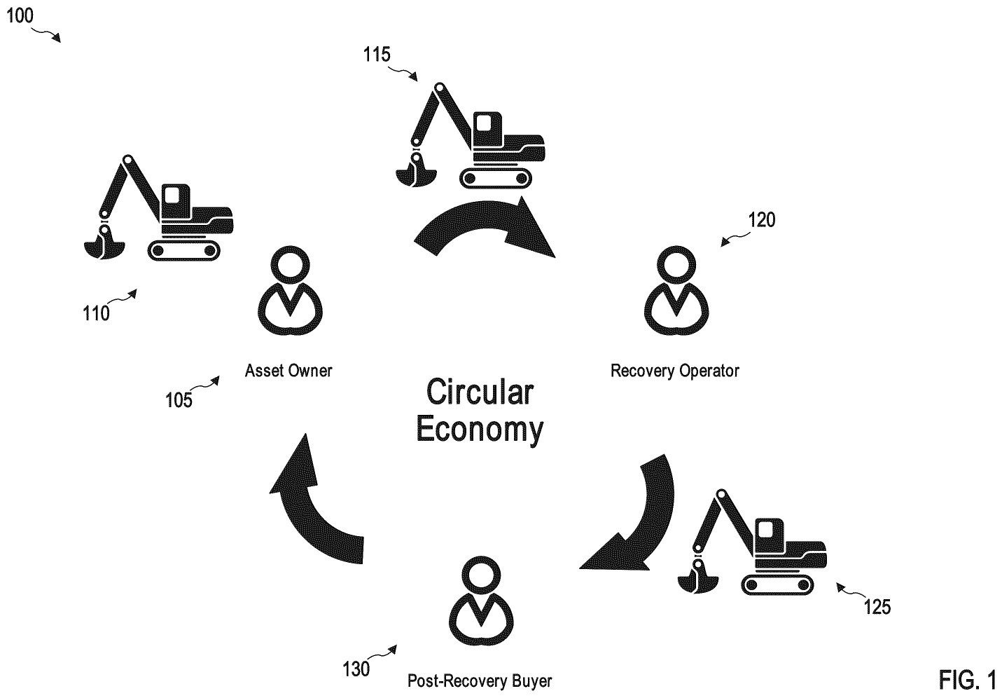

FIG. 1 is a diagram 100 illustrating elements of a circular economy in accordance with some aspects of the disclosure. For example, and asset owner 105 may own an asset 110. The asset 110 may be near the end of a useful life and the asset owner 105 may determine to dispose of the asset 110. The post-use asset 115 may then be transferred to a recovery operator 120 that may perform a recovery operation to produce a recovered asset 125. The recovered asset 125 may be purchased by post-recovery buyer 130. At the end of the useful life of the recovered asset 125, the post-recovery buyer 130 may take the role of the asset owner 105 and the cycle may begin again.

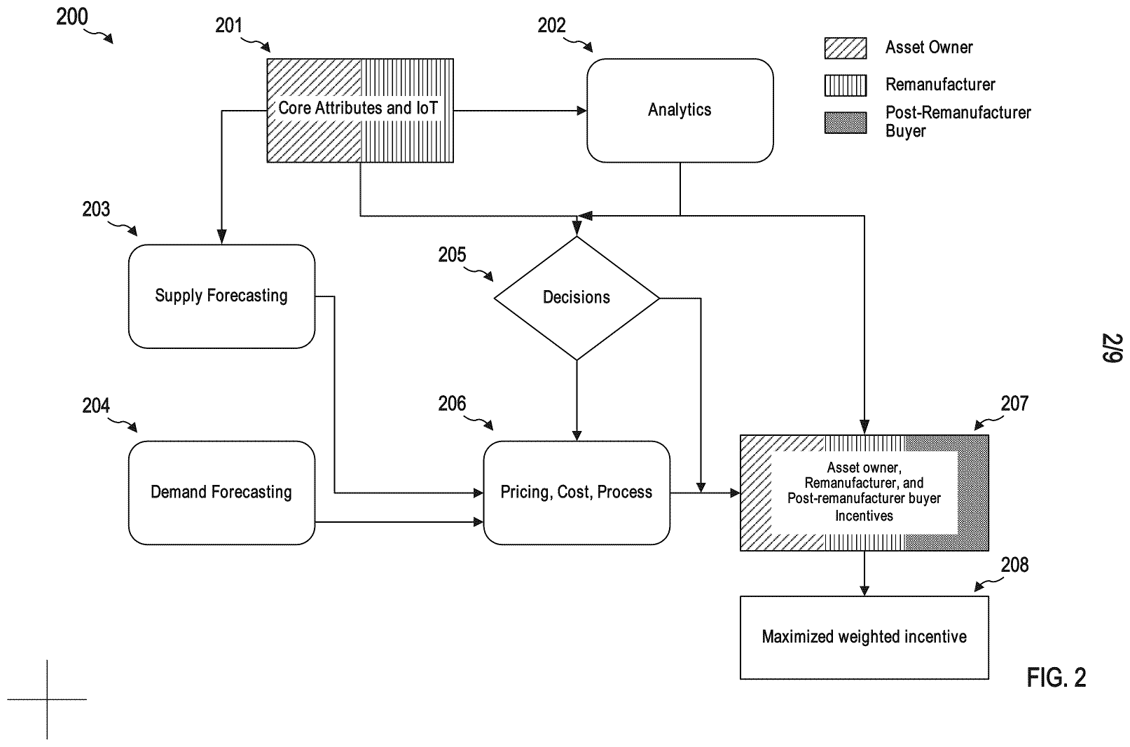

FIG. 2 is a diagram 200 illustrating an abstracted interaction between the stakeholders in the asset recovery decision problem. In FIG. 2Error! Reference source not found. we can see that there are multiple stakeholders interacting with each other and different models estimating various incentives (monetary, or other KPIs such as material savings or energy savings that may be associated with a monetary value) along with decision recommendations based on analytics. Recommending decisions and incentives is thus being modeled as an optimization problem. The asset owner and the remanufacturer may provide data regarding attributes of the core/asset 201 that may include internet of things (IoT) data. For example, the data regarding attributes of the core/asset 201 may include a set of attributes (xᵢ) of an core/asset “i”, a deployment history (xdᵢₜ) of core/asset i at time t, a maintenance history (xmᵢₜ) of core/asset i at time t, a scheduled end of life (xeofₜ) of core/asset i, IoT data (xiotᵢₜ) associated with core/asset i at time t, a performance degradation index (pdᵢₜ) of core/asset i at time t, a (n estimated) remaining useful life (rulᵢₜ) of a core/asset i at time t, and a damage severity or maintenance index (svᵢ) of core/asset i.

The data regarding the attributes of the core/asset 201 may be provided to an analytics module 202, a supply forecasting module 203, and a decisions module 205. The supply forecasting module 203 may identify a forecasted supply (sfₜ) at time t based on a probability (p(eaᵢ)) of an asset owner making an asset core i available for selling and a set of exogenous factors or external factors (y_{sf}) for supply forecasting. The demand forecasting module 204 may identify a forecasted demand (dfₜ) at time t, based on a set of exogenous factors or external factors (y_{df}) for demand forecasting.

The demand forecasting module 204 and the supply forecasting module 203 may provide the forecast data regarding a supply (e.g., the forecasted supply (sfₜ)) and demand (e.g., forecasted demand (y_{df})) associated with a particular asset/core to a pricing, cost, and process module 206. The pricing, cost, and process module 206 may also receive a decision made by a decisions module 205 that is in turn based on the data regarding attributes of the core/asset 201 and the analytics module 202. Based on the analytics module 202, the pricing, cost, and process module 206 and the decisions module 205 a set of asset-owner, remanufacturer, and post-remanufacturer buyer incentives 207 and a maximized weighted incentive 208 may be determined. The variables considered may include a reuse, repair, or remanufacturing cost (cᵢₛ) of core/asset i where S∈{reuse, repair, remanufacturing, scrap}, a reuse, repair, or remanufacturing process (processᵢₛ) of core/asset i where s ∈{reuse, repair, remanufacturing, scrap}, a total logistics cost of core/asset i (clᵢ) (e.g., a logistic cost related to a transfer between an asset owner and a recovery operator and between the recovery operator and a post-reman buyer), a probability of reuse, repair, or remanufacturing (p(sᵢ)) of core/asset i where s∈{reuse, repair, remanufacturing, scrap}, a product pricing (pᵢₛ) of core/asset i after reuse, repair, or remanufacturing where s∈{reuse, repair, remanufacturing, scrap}, a KPI j (kpiᵢⱼ _{_{recovery}}) of recovery operator for core/asset i, an incentive (incentiveᵢ _{_{owner}}.) for core/asset owner for core/asset i, an incentive (incentiveᵢ _{_{buyer}} for post-recovery core/asset buyer for core/asset i, an incentive (incentiveᵢ_{_{remanufacturer}} for recovery operator for core/asset i, a normalized weight (wiᵢ _{_{remanufacturer}}) of KPI j of recovery operator for core/asset i, a normalized weight (wᵢ_{_{owner}}) of incentive for core/asset owner for core/asset i, a normalized weight (wᵢ_{_{buyer}}) of incentive for post-reman core/asset buyer for core/asset i, a normalized weight (wᵢ_{_{remanufacturer}}) of incentive for recovery operator for core/asset i.

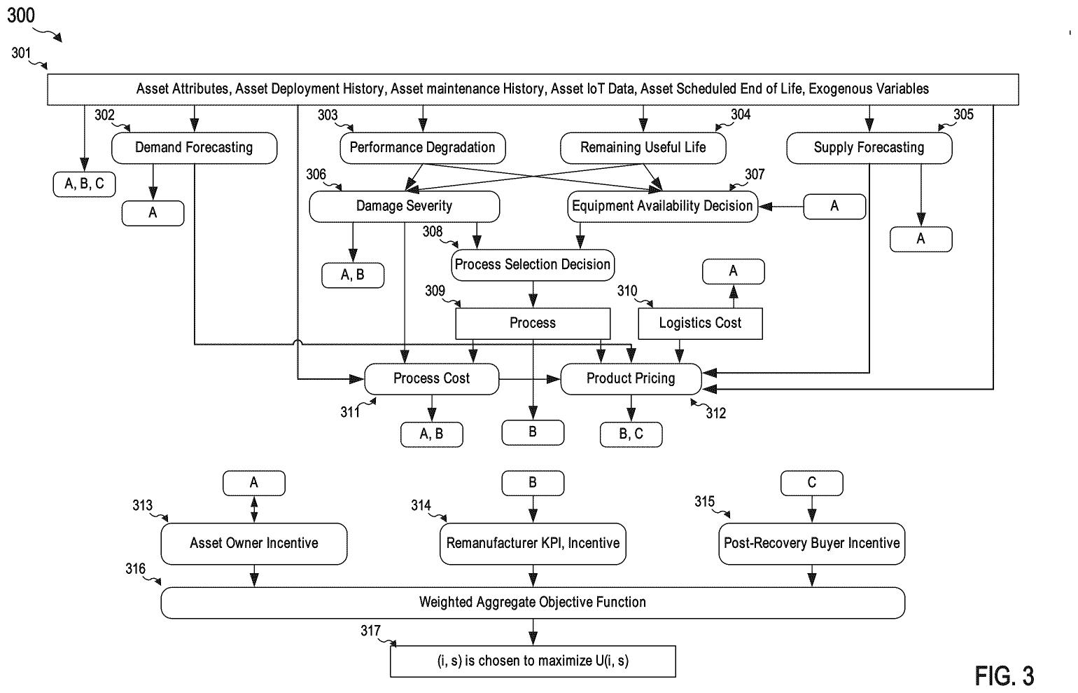

FIG. 3 is a diagram 300 illustrating a set of possible interactions in an asset recovery value chain for a decision recommendation problem modelled as a value maximization optimization problem. As illustrated in diagram 300, there may be multiple function outputs that contribute towards the overall objective function to be maximized. For example, a set of data 301 for a core/asset i may include data regarding a set of attributes (xᵢ), a deployment history (xdᵢₜ), a maintenance history (xmᵢₜ), a scheduled end of life (xeofᵢ), IoT data (xiotᵢₜ), a set of exogenous factors or external factors (y_{df}) for demand forecasting, and a set of exogenous factors or external factors (y_{sf}) for supply forecasting. The set of data 301 or components of the set of data 301 may be provided to a set of other modules including, e.g., a demand forecasting module 302, a performance degradation module 303, a remaining useful life module 304, a supply forecasting module 305, a process cost module 311, a product pricing module 312, and asset owner incentive module 313, a remanufacturer KPI and incentive module 314, and a post-recovery buyer incentive module 315.

In some aspects, the demand forecasting module 302 may receive the set of attributes (xᵢ), the scheduled end of life (xeofₜ), and the set of exogenous factors or external factors (y_{df}) for demand forecasting in the set of data 301. The demand forecasting module 302 may generate a forecasted demand (dfₜ) at time t based on the data received (or retrieved) from the set of data 301. For example, an equation df=f_{df} (xᵢ, y_{df}) or df=f_{df} (xᵢ, xeofᵢ, y_{df}) may be used to calculate the forecasted demand at the demand forecasting module 302.

In some aspects, the performance degradation module 303 may receive the set of attributes (xᵢ) and the IoT data (xiotᵢₜ). The performance degradation module 303 may generate the performance degradation index (pdᵢₜ) based on the set of attributes (xᵢ) and the IoT data (xiotᵢₜ). For example, an equation pdᵢₜ=fₚₐ (xᵢ, xiotᵢₜ) may be used to calculate the performance degradation index at the performance degradation module 303.

In some aspects, the remaining useful life module 304 may receive the set of attributes (xᵢ) and the IoT data (xiotᵢₜ). The remaining useful life module 304 may generate the (estimated) remaining useful life (rulᵢₜ) based on the set of attributes (xᵢ) and the IoT data (xiotᵢₜ). For example, an equation rulᵢₜ=fᵣᵤₜ (xᵢ, xiotᵢₜ) may be used to calculate the (estimated) remaining useful life at the remaining useful life module 304.

In some aspects, the supply forecasting module 305 may receive the set of attributes (xᵢ), the scheduled end of life (xeofᵢ), a (n estimated) remaining useful life (rulᵢₜ), and the set of exogenous factors or external factors (y_{sf}) for supply forecasting in the set of data 301. The supply forecasting module 305 may generate a forecasted supply (sfₜ) at time t based on the data received (or retrieved) from the set of data 301. For example, an equation sf=f_{sf} (xᵢ, xeofᵢ, rulᵢₜ, y_{sf}) may be used to calculate the forecasted supply at the supply forecasting module 305.

A damage severity module 306 may receive the set of attributes (xᵢ), the maintenance history (xmᵢₜ), the (estimated) remaining useful life (rulᵢₜ) generated by the remaining useful life module 304, and the performance degradation index (pdᵢₜ) generated by the performance degradation module 303. The damage severity module 306 may generate a damage severity or maintenance index (svᵢ) based on the data received (or retrieved) by the damage severity module 306. For example, an equation svᵢ=fₛᵥ (xmᵢₜ, rulᵢₜ, pdᵢₜ, xᵢ) may be used to calculate the damage severity or maintenance index at the damage severity module 306.

An equipment availability decision module 307 may receive the set of attributes (xᵢ), the scheduled end of life (xeofᵢ), the performance degradation index (pdᵢₜ) generated by the performance degradation module 303, the (estimated) remaining useful life (rulᵢₜ) generated by the remaining useful life module 304, and an incentive (incentiveᵢ_{_{owner}}) generated at an asset owner incentive module 313. The equipment availability decision module 307 may generate the probability of owner making a core/asset available for selling (p(eaᵢ)) based on the data received (or retrieved) by the equipment availability decision module 307. For example, an equation p(eaᵢ)=f_{availability} (xᵢ, xeofᵢ, pdᵢₜ, rulᵢₜ, incentiveᵢ_{_{owner}}) may be used to calculate the probability of owner making a core/asset available for selling at the equipment availability decision module 307.

In some aspects, a process selection decision module 308 may receive the damage severity or maintenance index (svᵢ) from the damage severity module 306 and the probability (p(eaᵢ)) of the owner making the core/asset available for selling from the equipment availability decision module 307. The process selection decision module 308 may calculate a probability for performing each process that may be used to dispose of the core/asset by the owner. For example, an equation p(s)=f_{process} (SVᵢ) may be used to calculate a probability for each of a reuse process, a repair process, a remanufacturing process, or a scrap process in a set of possible processes s∈{reuse, repair, remanufacturing, scrap} at the process selection decision module 308.

The probabilities generated at the process selection decision module 308 may be used to determine a process(s) 309. Each process(s) in the set of processes may be associated with the total logistics cost (clᵢ) 310. Based on a selected process(s), a set of attributes (xᵢ), and the damage severity or maintenance index (svᵢ), a process cost module 311 may calculate a process cost for the selected process. For example, an equation cᵢₛ=f_{cost} (S, xᵢ, SVᵢ) may be used by the process cost module 311 to calculate a cost of a selected reuse process, a repair process, and/or a remanufacture process.

A product pricing module 312 may receive an identification of the selected process(s), the set of attributes (xᵢ), the cost of the process (cᵢₛ), the forecasted demand (dfₜ), the forecasted supply (sfₜ), and the logistical cost (clᵢ). The product pricing module 312 may then compute a post-reuse,-repair, or -remanufacture pricing (pᵢₛ). For example, an equation pᵢₛ=f_{pricing} (xᵢ, cᵢₛ, df, sf, clᵢ) may be used by the product pricing module 312 to calculate the product pricing based on the selected process(s), the set of attributes (xᵢ), the cost of the process (cᵢₛ), the forecasted demand (dfₜ), the forecasted supply (sfₜ), and the logistical cost (clᵢ).

An asset owner incentive module 313 may determine an incentive for the core/asset owner (incentiveᵢ_{_{owner}}) and a decision recommendation whether to sell a core/asset. The asset owner incentive module 313 may receive the set of attributes (xᵢ), the forecasted supply (sfₜ), the forecasted demand (dfₜ), the damage severity or maintenance index (svᵢ), the logistical cost (clᵢ), and the cost of the process (cᵢₛ) and identify (or calculate) an incentive for the core/asset owner (incentiveᵢ_{_{owner}}) and the decision recommendation (decisionᵢ_{_{owner}}) whether to sell the core/asset. For example, the asset owner incentive module 313 may use a function incentiveᵢ_{_{owner}}=f_{incentive}_{_{owner}} (xᵢ, sf, df, svᵢ, clᵢ, cᵢₛ) to calculate an incentive for the core/asset owner and may use the incentiveᵢ_{_{owner}} to calculate a decisionᵢ_{_{owner}} based on a function (e.g., f_{decisioni}_{_{onwner}} (incentiveᵢ_{_{owner}}).

A remanufacturer KPI and incentive module 314 may identify a set of KPIs piₛᵢⱼ_{_{recovery}} for the identified process(s). The set of KPIs (piₛᵢⱼ _{_{recovery}}) may be influenced by government agency norms, recovery operator's sustainability goals and commitments, and other such factors. The set of KPIs may include a material amount recovered, a core disposal rate, a new material avoided, a process energy avoided, a material energy avoided, a process emissions avoided, a material emissions avoided, a product salvage rate, a core/product value ratio, a number of service lifecycles, or other such KPIs. The remanufacturer KPI and incentive module 314 may also receive the set of attributes (xᵢ), the cost of the process (cᵢₛ), and the post-reuse,-repair, or -remanufacture pricing (pᵢₛ). The set of attributes (xᵢ), the cost of the process (cᵢₛ), and the post-reuse,-repair, or -remanufacture pricing (pᵢₛ) may be used to identify (or calculate) an incentive (incentiveᵢ_{_{remanufacturer}} for the recovery operator for the core/asset i. For example, a function, incentive_{i,} _{_{remanufacturer}}=f_{incentive}_{_{recovery}} (xᵢ, cᵢₛ, pᵢₛ) may be used to identify the incentive for the recovery operator and may use the incentive_{i,}_{_{remanufacturer}} to calculate a decisionᵢ_{_{remanufacturer}} based on a function (e.g., f_{decisioni}_{_{remanufacturer}} (incentiveᵢ_{_{rmanufacturer}}) at the remanufacturer KPI and incentive module 314.

A post-recovery buyer incentive module 315 may determine a post-reuse,-repair, or -remanufacture asset buyer for the core/asset buyer (incentiveᵢ_{_{buyer}}) and a decision recommendation whether to accept a reused/repaired/remanufactured core/asset for a buyer. The post-recovery buyer incentive module 315 may receive the set of attributes (xᵢ) and the post-reuse,-repair, or -remanufacture pricing (pᵢₛ) and identify (or calculate) an incentive for the post-reuse,-repair, or -remanufacture asset buyer (incentiveᵢ_{_{buyer}}) and the decision recommendation (decisionᵢ_{_{buyer}}) whether to accept a reused/repaired/remanufactured core/asset. For example, the post-recovery buyer incentive module 315 may use a function incentiveᵢ_{_{buyer}}=f_{incentive}_{_{buyer}} (xᵢ, pᵢₛ) to calculate an incentive for the post-reuse,-repair, or -remanufacture asset buyer and may use the incentiveᵢ_{_{buyer}} to calculate a decisionᵢ_{_{buyer}} based on a function (e.g., fdecisionᵢ_{_{buyer}} (incentiveᵢ_{_{buyer}})).

A weighted aggregate objective function module 316 may, in some aspects, obtain weight information for a set of individual analytic models (e.g., machine learning models for a core/asset owner, a remanufacturer, a post-recovery buyer, and a recovery process decision) such as Ws_{ij i}_{_{remanufacturer}}, wᵢ_{_{owner}}, wᵢ_{_{buyer}}, wᵢ_{_{recovery}}. The weights, in some aspects, may depend on the business scenario and context. In some aspects, the set of weights are not obtained and different modeling and/or solution techniques may be employed, e.g., game theory, multi-agent multi-objective reinforcement learning, multi-objective genetic algorithms. For the following discussion, it is assumed that weights may be obtained and an aggregate objective function may be formulated.

The weight information may be used to generate a weighted aggregate objective function U that may be a weighted sum of the KPIs (kpiₛᵢ_{_{i recovery}}) and the incentives of the owner (incentiveᵢ_{_{owner}}), the recovery operator (incentiveᵢ_{_{recovery}}) and post-reman asset buyer (incentiveᵢ_{_{buyer}}). For example, the aggregate objective function U may be defined as U=(wᵢ_{_{owner}}*incentiveᵢ_{_{owner}})+(Wsᵢⱼ_{_{remanufacturer}}*kplₛᵢⱼ_{_{recovery}})+ (wᵢ_{_{recovery}}*incentiveᵢ_{_{recovery}}, +(wᵢ_{_{buyer}}*incentiveᵢ_{_{buyer}}. The weighted aggregate objective function U generated by the weighted aggregate objective function module 316 may then be used to generate, for a particular core/asset i, a selection of a process(s) that maximizes the weighted aggregate objective function U 317.

Using the above definitions, the optimization task can be modeled as argmax_{i,s} max (U) for the asset recovery process. The result of the optimization, in some aspects, may assist in recommending an incentive to a core/asset owner. In some aspects, the optimization may include recommending a disposition decision to an asset owner. The optimization may include, in some aspects, recommending a recovery process (a reuse process, a repair process, a remanufacture process, etc.) to a recovery operator. In some aspects, the optimization may include recommending a product pricing to a recovery operator and a post-recovery core/asset buyer. These recommendations may include a recommendation of incentives to a recovery operator and a post-recovery asset buyer.

In relation to the diagram 300 of FIG. 3, in some aspects, a related method may comprise (1) understanding the value chain in the asset recovery process as well as the various KPIs, (2) creating a value interaction map, (3) understanding and creating functional models of the different sub-problems in the value chain (e.g., estimating remaining useful life, demand forecasting, etc.), (4) identifying data elements (e.g., inputs) for each sub-problem, (5) creating either pre-trained models (e.g., function models) for the sub-problem using historical data or randomized parameters of the model for the sub-problems, (6) dynamically leveraging the value interaction map and connecting the function models, where the output of one model can be an input to another, (7) Re-training the function models using an optimization algorithm where the objective function may be max (U), and, during an application phase, (8) using the value interaction map and the trained function models along with respective incoming data to compute incentives for the stakeholders in the value chain and generate decision recommendations for each stakeholder. It should be noted that although the value chain shown in FIG. 3 is defined at a general level, there can be a lot of customization based on a business context and core/asset.

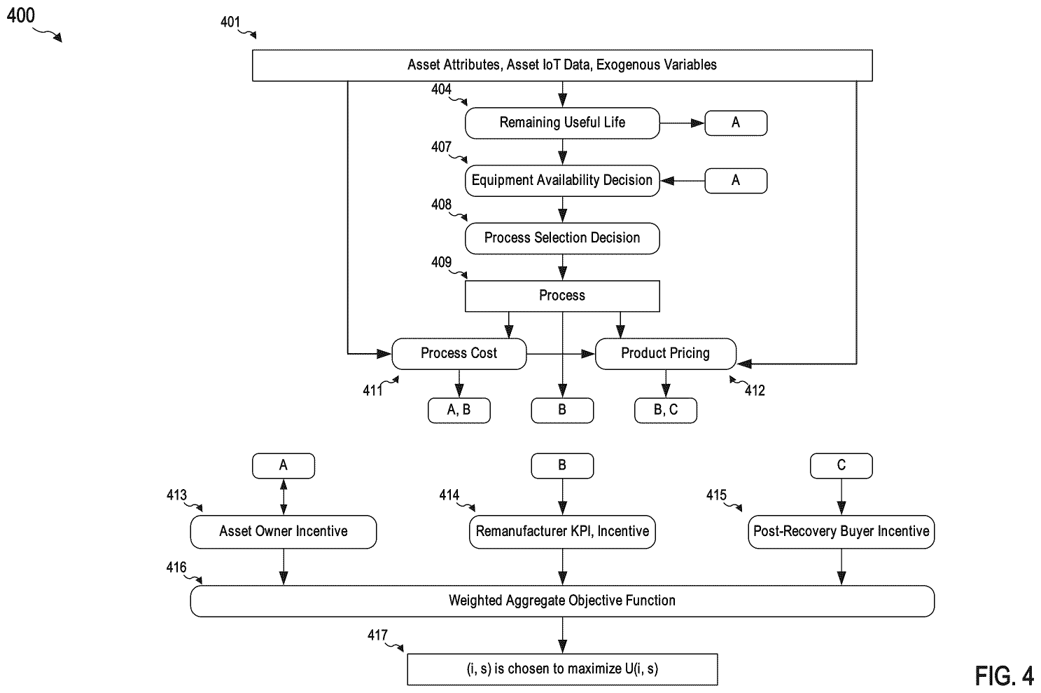

FIG. 4 is a diagram 400 illustrating an example of a simplified version of a set of models (e.g., a value chain) depicted in FIG. 3. The diagram 400 may be applied to a use case relating to an asset recovery operation for an air-compressor (AC). In some aspects, the stakeholders in the value chain may include an asset owner (O), a remanufacturer (R) and a post-remanufacture buyer (RB) in a value chain for the remanufacturing of AC. As shown in FIG. 4, the output of the remaining useful life model 404 of the core/asset may be one factor for O and R to decide whether to sell and buy the asset, respectively. As in FIG. 3, the models may be based on a set of data 401 that is similar to the set of data 301. In some aspects, R may conduct one of two processes 409-a repair process (Re) or a remanufacture process (Rm). Based on the core/asset, these processes may also be associated with costs calculated by process cost model 411 that R may consider while computing a set of KPIs at remanufacturer KPI and incentive model 414. In some aspects, two KPIs may be a maximization target for R, e.g., profit (PF_{R}) and material saving (MS_{R}). Similarly, economic savings (PRO) and material saving (MSₒ) associated with the Re or Rm may be considered for O at asset owner incentive (KPI) model 413 (e.g., compared to discarding the asset and buying a brand-new asset). After repair or remanufacturing, a post recovery asset buyer (B) may buy the repaired/remanufactured core/asset if it satisfies a threshold KPI, e.g., economic savings (PR_{B}). In some aspects, the KPIs of the stakeholders may be the incentives based on which the decision recommendations may be recommended.

In order to implement the methods associated with FIGS. 3 and 4, some aspects include a data preparation. For asset recovery, the data input, in some aspects, may include (but is not limited to) asset sensor data, asset event data, asset maintenance history, asset cost, remanufacturing/repair costs, historical KPIs, historical buying/selling decisions, and so on. As discussed above, in some aspects, there are several sub-problems associated with the asset recovery value chain where a machine learning algorithm may be involved. In some aspects, several data preparation steps may be implemented before the data is used as an input to a set of machine learning algorithms. These data preparation steps, in some aspects, may be applied to the input data before it is ingested by the set of machine learning algorithms. While specific data preparation methods may be described below, it is understood that they are merely exemplary and not limiting.

In some aspects, the data preparation methods may include noise and/or outlier removal from equipment attributes sensor data. The data preparation method, in some aspects, may include missing-data imputation for sensor data. If text data is involved, then the data preparation methods may include special character removal, stop word removal, normalization of abbreviations, normalization of synonyms, text correction, and/or stemming of the extracted text data. In some aspects, once data is prepared it is further divided into a training set and a validation set. The training set, in some aspects, is used during a model training phase, while the validation set is used for evaluating the model.

In some aspects, a value chain map of the asset recovery process is leveraged to identify the machine learning models to be trained. In diagram 400, the models to be trained include a remaining useful life model 404, an equipment availability decision model 407, a process selection decision model 408, a process cost model 411, a product pricing model 412, an asset owner incentive (KPI) model 413, a remanufacturer KPI and incentive model 414, a post-recovery buyer incentive (KPI) model 415, and a weighted aggregate objective function model 416. These models may then be used to determine a core/asset and process (e.g., {i, s}) 417 to maximize the aggregate objective function.

A base architecture using the machine learning models, in some aspects, may be created using the value chain map. As shown in the value chain map in FIG. 4, the output of one model can be an input to another model. Traditionally, these models are trained individually and thus make localized sub-optimal decisions. However, the method described herein may train the models collectively and hence make more informed and optimal decisions. The models in the base architecture, in some aspects are instantiated with random weights. The models may then be trained using historical data, mapping the respective input and output for that model. This base architecture is subsequently used to train all the models collectively using an optimization algorithm where the objective is to maximize the aggregated objective function U as defined in earlier sections.

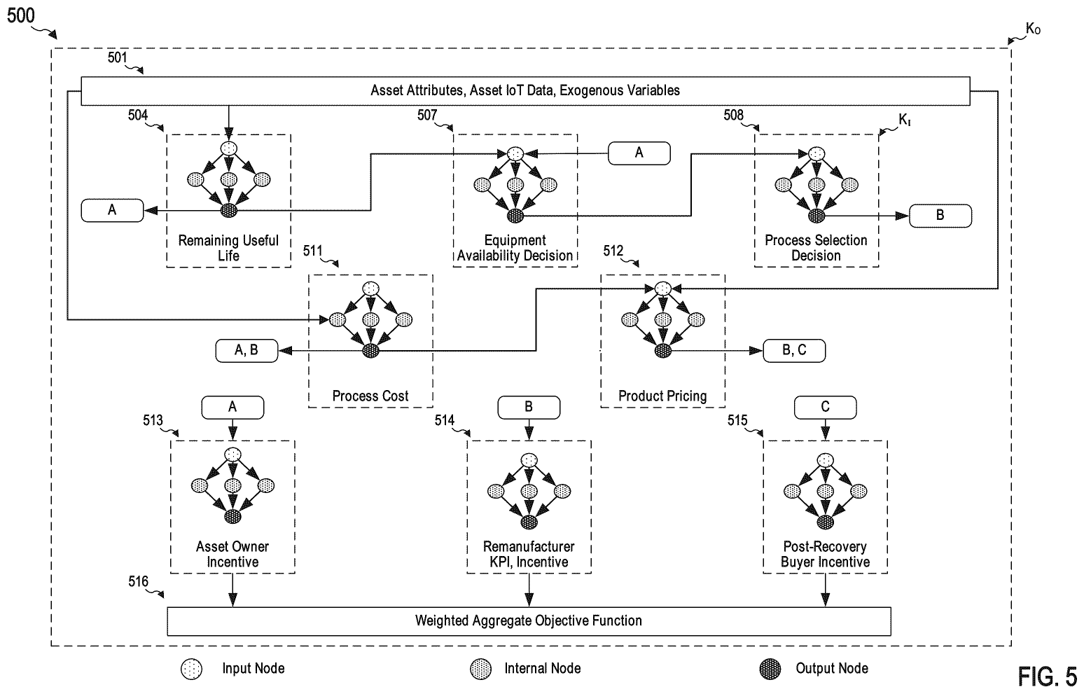

FIG. 5 is a diagram 500 illustrating a set of machine-trained models corresponding to the models depicted in FIG. 4. In some aspects, there may be two phases to training the model parameters for the models depicted in FIG. 5 that may be iterated. As described above, the inputs to each model may be included in a set of data 501 similar to the sets of data 301 and 401 or FIGS. 3 and 4, respectively. During a first phase, or step, a set of pre-trained models may be built for the sub-problems defined in the base architecture based on the value chain map (e.g., the value chain map of FIG. 4). A second phase may include training the model parameters collectively to maximize the weighted aggregate objective function (U) 516 based on the connections between the models (e.g., training an additional set of weights associated with connections between the output of one model and the input of another model). For example, the set of models may include an equipment availability decision model 507, a process selection decision model 508, a process cost model 511, a product pricing model 512, an asset owner incentive (KPI) model 513, a remanufacturer KPI and incentive model 514, a post-recovery buyer incentive (KPI) model 515, and a weighted aggregate objective function model 516. These models may then be used to determine a core/asset and process (e.g., {i, s}) 517 to maximize the aggregate objective function and a first phase of training may include separately training a set of weights associated with internal nodes of each model based on the inputs to the model and the output from the model without considering connections to other models. The second phase may include treating the connected models as a single model in which at least one additional weight is trained for each model output (e.g., the output of the remaining useful life model 504) that is used as an input for a different model (e.g., the input of the asset owner incentive (KPI) model 513) in the set of models depicted in diagram 500. In some aspects, both phases may utilize an optimization algorithm that maximizes the aggregated objective function U based on historical data for model training.

In some aspects, each model parameter is updated using two cycles alternatively. For every training iteration in a set of Kₒ iterations for training an aggregated objective function opt_{y} associated with the collective (fully connected) model, parameters of each model are individually updated using input-output mapping of the historical data and loss function minimization for a set of K_{J} iterations. For example, the remaining useful life model is trained over a set of K iterations using historical input sensor and historical data identifying a true remaining useful life. The optimization algorithm used for the Kᵢ iterations, in some aspects, may include minimizing a squared error. It should be noted that each model can have different Kᵢ values. The remaining useful life model may then be updated over a set of Kₒ iterations based on an optimization algorithm for maximizing U. In some aspect, the two-phase training methodology may account for both local and global effects.

For example, the local effects may be introduced/accounted for by the individual model training optimization iterations (Kᵢ), while the global effects may be introduced/accounted for by the aggregated objective function U optimization iterations (Kₒ). As the aggregated objective function U incorporates effects of all models in the value chain map, while maximizing U it introduces global effects on all the individual models. This two-phase (e.g., alternating) model parameter update cycle, in some aspects, continues until the weight values and/or the output of the set of models (U) stabilizes. The optimization algorithms that are applicable for such process can be gradient-free methods like genetic algorithms or gradient-based methods like gradient descent, etc.

Examples of applicable machine learning models may include neural networks, support vector machines, etc. The method, in some aspects, may be agnostic to the optimization algorithm and the machine learning models being used. The selection of the optimization algorithm and the machine learning models, in some aspects, may depend on the asset under consideration, the sub-problems in the value chain map, and the availability and type of data. In the example of air compressor asset recovery, the machine learning models may be neural networks that are trained using stochastic gradient descent, while the optimization algorithm used for maximization of U is a genetic algorithm.

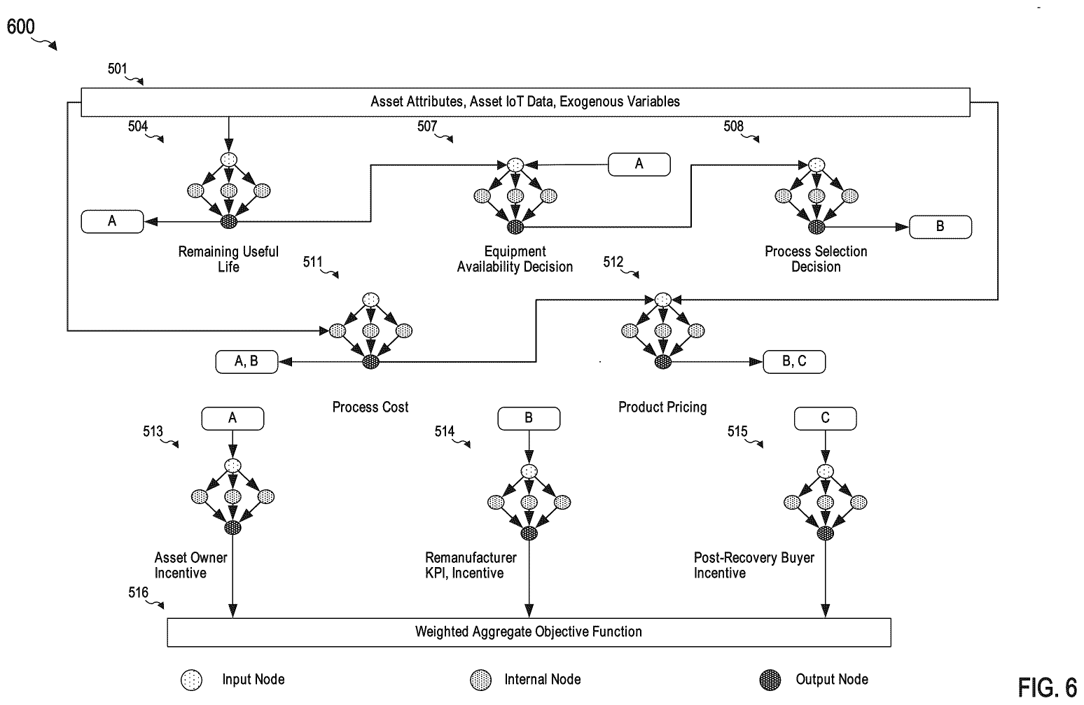

FIG. 6 is a diagram 600 of the trained models that may be used for generating a set of decision recommendations for the stakeholders. As the elements of FIG. 6 are the same elements of FIG. 5 after having been trained, the numbering of the elements will retain the numbering from FIG. 5. As discussed above, the decision recommendations may relate to whether to sell and/or buy a particular core/asset, a recovery process to use for the core/asset, and a set of KPIs (e.g., incentives) for each stakeholder. For example, during an inference phase, the data pre-processing steps discussed above may be applied to real-time data associated with a particular asset/core. Subsequently, the processed real-time data may be provided to the trained machine learning models to estimate the KPIs and provide the decision recommendations. The various KPIs and decision recommendations computed by the set of models may then be displayed to the users.

The above ways of creating multiple single learners (e.g., machine-trained models) forming an ensemble, in some aspects, may result in a trained deterministic ensemble learner (e.g., machine-trained model) during an inference phase. In some aspects, a dropout operation may be kept inactive during the inference phase. Each trained learner (e.g., machine-trained models) may be modified to a stochastic model by keeping the dropout operation active during the inference phase. Thus, when an input is passed through the trained learner multiple times with dropout active, the network structure is modified randomly during each pass and different outputs can be obtained. Each randomly modified structure of the trained learner is a component of the ensemble.

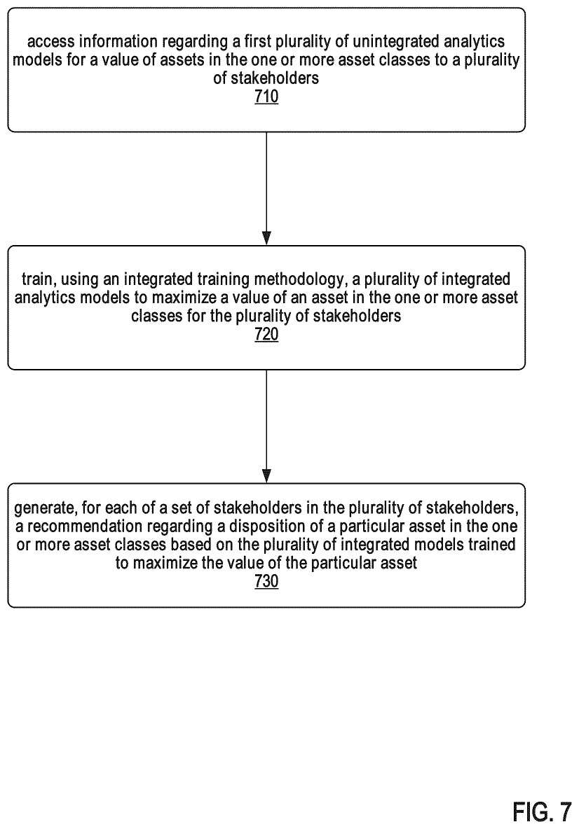

FIG. 7 is a flow diagram 700 illustrating a method for one or more recommendations regarding disposition of an asset in one or more asset classes. At 710, the method may access information regarding a first plurality of unintegrated analytics models for a value of assets in the one or more asset classes to a plurality of stakeholders. The information may include a set of attributes associated with one or more cores/assets collected by stakeholders or sensors associated with the one or more cores/assets. As discussed in relation to FIGS. 3 and 4 the set of attributes may, in some embodiments, include data regarding a set of attributes (xᵢ), a deployment history (xdᵢₜ), a maintenance history (xmᵢₜ), a scheduled end of life (xeofᵢ), IoT data (xiotᵢₜ), a set of exogenous factors or external factors (y_{df}) for demand forecasting, and a set of exogenous factors or external factors (y_{sf}) for supply forecasting. The unintegrated analytics models may include existing sub-models (e.g., machine-trained models) in a particular value chain for the one or more asset classes that have been individually trained to maximize a local variable (e.g., a variable associated with the sub-model or the stakeholder associated with the sub-model).

At 720, the method may train, using an integrated training methodology, a plurality of integrated analytics models to maximize a value of an asset in the one or more asset classes for the plurality of stakeholders. As discussed above the integrated training methodology may include using historical data to preliminarily train individual analytics models in the plurality of integrated analytics models. The method may then map a set of outputs from a corresponding first set of unintegrated analytics models in the plurality of unintegrated analytics models to a set of inputs of a second set unintegrated analytics models in the plurality of unintegrated analytics models. The mapping may be used to generate the plurality of integrated analytics models (e.g., the set of models that, collectively, define the aggregated objective function U). The method may then use the historical data and the individual analytics models to train the plurality of integrated analytics models to maximize a value function (e.g., the aggregated objective function U). As described in relation to FIG. 5, the method may train each model over a set of individual model training optimization iterations (Kᵢ) and then train the plurality of integrated models (e.g., the aggregated objective function U) over a set of optimization iterations (Kₒ).

In some aspects, the historical data may include one or more of asset sensor data, asset event data, asset maintenance history, asset cost, remanufacturing costs, repair costs, historical KPIs, historical buying decisions, or historical selling decisions. The plurality of integrated models, in some aspects, includes two or more of a remaining-useful-life model, an asset-owner KPI estimation model, an asset recovery-process selection model, a remanufacturer KPI estimation model, a post remanufacture buyer KPI estimation model, an asset owner selling decision estimation model, a remanufacturer asset acceptance decision estimation model, or a post remanufacture buyer asset buying estimation model. As described in relation to FIG. 3, the plurality of integrated models, in some aspects, may include a demand forecasting module 302, a performance degradation module 303, a remaining useful life module 304, a supply forecasting module 305, a process cost module 311, a product pricing module 312, and asset owner incentive module 313, a remanufacturer KPI and incentive module 314, and a post-recovery buyer incentive module 315.

At 730 the method may generate, for each of a set of stakeholders in the plurality of stakeholders, a recommendation regarding a disposition of a particular asset in the one or more asset classes based on the plurality of integrated models trained to maximize the value of the particular asset. In some aspects, the recommendation regarding the disposition of the particular asset generated for a particular stakeholder in the set of stakeholders includes at least one of a recommendation to retain the particular asset, a recommendation of a price at which to sell the particular asset, a recommendation for a recovery process for a recovery operator.

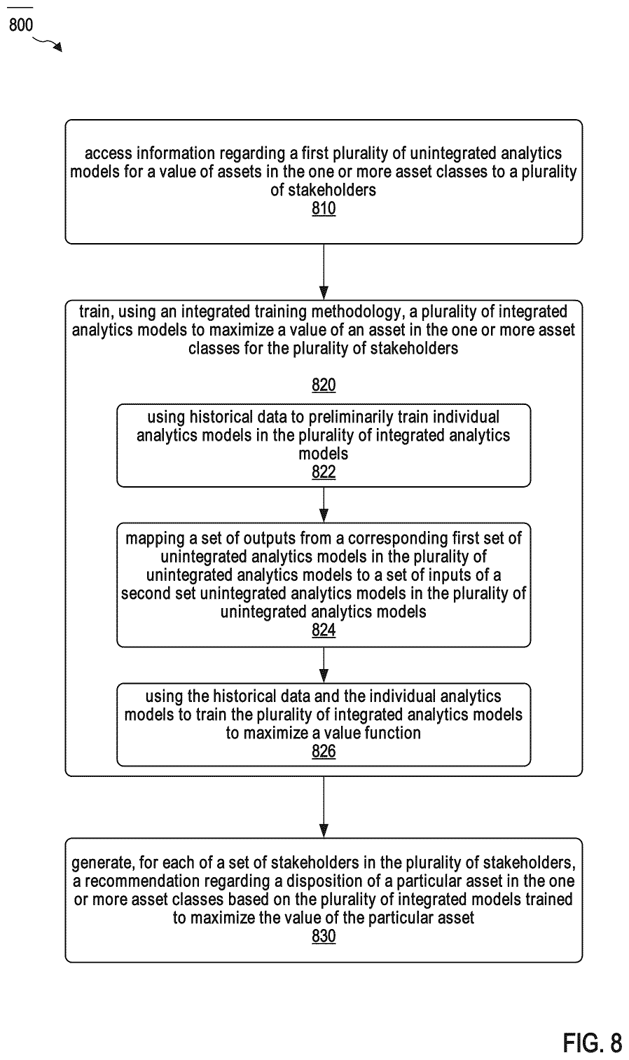

FIG. 8 is a flow diagram 800 illustrating a method for one or more recommendations regarding disposition of an asset in one or more asset classes. At 810, the method may access information regarding a first plurality of unintegrated analytics models for a value of assets in the one or more asset classes to a plurality of stakeholders. The information may include a set of attributes associated with one or more cores/assets collected by stakeholders or sensors associated with the one or more cores/assets. As discussed in relation to FIGS. 3 and 4 the set of attributes may, in some embodiments, include data regarding a set of attributes (xᵢ), a deployment history (xdᵢₜ), a maintenance history (xmᵢₜ), a scheduled end of life (xeofᵢ), IoT data (xiotᵢₜ), a set of exogenous factors or external factors (y_{df}) for demand forecasting, and a set of exogenous factors or external factors (y_{sf}) for supply forecasting. The unintegrated analytics models may include existing sub-models (e.g., machine-trained models) in a particular value chain for the one or more asset classes that have been individually trained to maximize a local variable (e.g., a variable associated with the sub-model or the stakeholder associated with the sub-model).

At 820, the method may train, using an integrated training methodology, a plurality of integrated analytics models to maximize a value of an asset in the one or more asset classes for the plurality of stakeholders. As discussed above the integrated training methodology may include, at 822, using historical data to preliminarily train individual analytics models in the plurality of integrated analytics models. The method may then, at 824, map a set of outputs from a corresponding first set of unintegrated analytics models in the plurality of unintegrated analytics models to a set of inputs of a second set unintegrated analytics models in the plurality of unintegrated analytics models. The mapping may be used to generate the plurality of integrated analytics models (e.g., the set of models that, collectively, define the aggregated objective function U). In some aspects, the mapping may be based on stakeholder interactions in a CE value chain. The method may then, at 826, use the historical data and the individual analytics models to train the plurality of integrated analytics models to maximize a value function (e.g., the aggregated objective function U). As described in relation to FIG. 5, the method may train each model over a set of individual model training optimization iterations (Kᵢ) and then train the plurality of integrated models (e.g., the aggregated objective function U) over a set of optimization iterations (Kₒ).

In some aspects, the historical data may include one or more of asset sensor data, asset event data, asset maintenance history, asset cost, remanufacturing costs, repair costs, historical KPIs, historical buying decisions, or historical selling decisions. The plurality of integrated models, in some aspects, includes two or more of a remaining-useful-life model, an asset-owner KPI estimation model, an asset recovery-process selection model, a remanufacturer KPI estimation model, a post remanufacture buyer KPI estimation model, an asset owner selling decision estimation model, a remanufacturer asset acceptance decision estimation model, or a post remanufacture buyer asset buying estimation model. As described in relation to FIG. 3, the plurality of integrated models, in some aspects, may include a demand forecasting module 302, a performance degradation module 303, a remaining useful life module 304, a supply forecasting module 305, a process cost module 311, a product pricing module 312, and asset owner incentive module 313, a remanufacturer KPI and incentive module 314, and a post-recovery buyer incentive module 315.

At 830 the method may generate, for each of a set of stakeholders in the plurality of stakeholders, a recommendation regarding a disposition of a particular asset in the one or more asset classes based on the plurality of integrated models trained to maximize the value of the particular asset. In some aspects, the recommendation regarding the disposition of the particular asset generated for a particular stakeholder in the set of stakeholders includes at least one of a recommendation to retain the particular asset, a recommendation of a price at which to sell the particular asset, a recommendation for a recovery process for a recovery operator.

The use of the invention will be in asset recovery applications in circular economy business models where there are multiple stakeholders in a value chain and need optimized decision recommendations so that their value is maximized.

According to the examples described above, a method is presented for decision recommendations for stakeholders in an asset recovery value chain. The method, in some aspects, includes defining abstract stakeholders, their value interactions, and possible decisions in the asset recovery process in order to generate individual models and a set of integrated models related to the different components of the asset recovery value chain. In some aspects, a set of information variables relevant for each model in the value chain may be determined and accessed/retrieved from a centralized information hub or from the individual stakeholders. The integrated models, in some aspects, may be trained (e.g., via a machine-learning operation) based on the identified information variables and the defined value interactions.

As discussed above, the method considers (e.g., takes into account) (1) that there may be multiple stakeholders in the value chain, (2) that the multiple stakeholders may be interconnected, and (3) that the decision recommendation problem is dependent on multiple data-driven machine learning models. As opposed to approaches treating each decision in the value chain as a separate decision to be made by each stakeholder in which training a machine learning model may involve mapping a set of inputs to an output (or set of outputs) independently, the method described above incorporates knowledge of an interconnectivity/dependency of the stakeholders. Accordingly, in some aspects of the method, the output of one machine learning model affects the input and/or the output of another machine learning model. For example, as opposed to modeling demand forecasting and product pricing estimations independently, in the case of the methods described above as applied to asset recovery, these models may be developed and or trained jointly or as part of an integrated set of models. Accordingly, the integrated training of the models is based on decisions and values of the different stakeholders. The values and decisions of the stakeholders, in some aspects, may conflict. However, as described above, multiple methods to combine conflicting values and decisions for model training in asset recovery may be applied implemented.

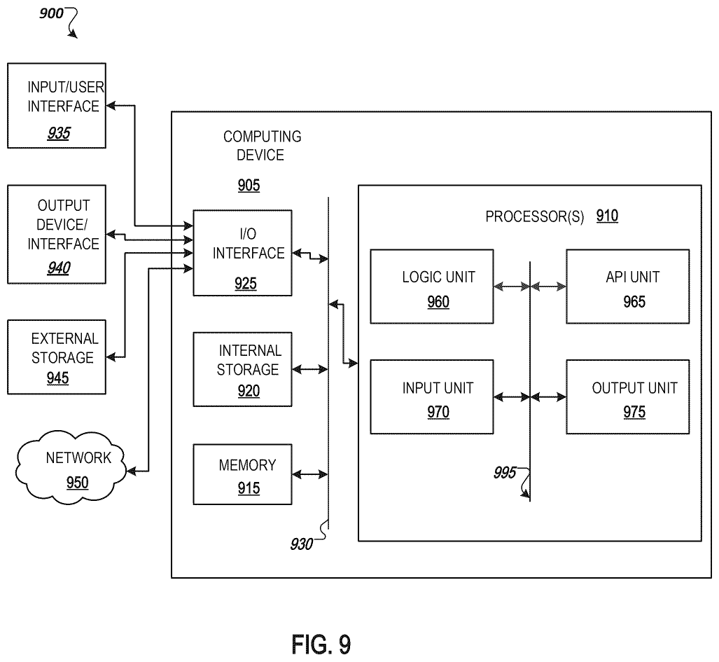

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or IO interface 925, any of which can be coupled on a communication mechanism or bus 930 for communicating information or embedded in the computer device 905. IO interface 925 is also configured to receive images from cameras or provide images to projectors or displays, depending on the desired implementation.

Computer device 905 can be communicatively coupled to input/user interface 935 and output device/interface 940. Either one or both of the input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via IO interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

IO interface 925 can include but is not limited to, wired and/or wireless interfaces using any communication or IO protocols or standards (e.g., Ethernet, 902.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, the input unit 970, the output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide an output based on the calculations described in example implementations.

Processor(s) 910 can be configured to access information regarding a first plurality of unintegrated analytics models for a value of assets in one or more asset classes to a plurality of stakeholders. The processor(s) 910 may also be configured to train, using an integrated training methodology, a plurality of integrated analytics models to maximize a value of an asset in the one or more asset classes for the plurality of stakeholders. The processor(s) 910 may further be configured to generate, for each of a set of stakeholders in the plurality of stakeholders, a recommendation regarding a disposition of a particular asset in the one or more asset classes based on the plurality of integrated models trained to maximize the value of the particular asset. The processor(s) 910 may further be configured to map a set of outputs from a corresponding first set of unintegrated analytics models in the plurality of unintegrated analytics models to a set of inputs of a second set unintegrated analytics models in the plurality of unintegrated analytics models. The processor(s) 910 may also be configured to use historical data to preliminarily train individual analytics models in the plurality of integrated analytics models. The processor(s) 910 may also be configured to use the historical data and the individual analytics models to train the plurality of integrated analytics models to maximize a value function.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

1. A method of providing one or more recommendations regarding a disposition of one or more asset classes comprising:
accessing information regarding a plurality of unintegrated analytics models for a value of assets in the one or more asset classes to a plurality of stakeholders;
training, using an integrated training methodology, a plurality of integrated analytics models to maximize the value of an asset in the one or more asset classes for the plurality of stakeholders;
calculating an asset owner incentive, a remanufacture incentive, and a post-recovery buyer incentive based on asset data and output of the plurality of integrated analytics models; and
generating, for each of a set of stakeholders in the plurality of stakeholders, a recommendation regarding the disposition of a particular asset in the one or more asset classes based on the output of the plurality of integrated analytics models trained to maximize the value of the particular asset, and the calculated asset owner incentive, the remanufacture incentive, and the post-recovery buyer incentive.

2. The method of claim 1, wherein the recommendation regarding the disposition of the particular asset generated for a particular stakeholder in the set of stakeholders comprises at least one of a first recommendation to retain or sell the particular asset, a second recommendation of a price at which to sell the particular asset, a third recommendation for a recovery process for a recovery operator to recover the particular asset for remanufacture, or a fourth recommendation to accept the particular asset for a post-recovery buyer.

3. The method of claim 1, wherein training the plurality of integrated analytics models comprises:
mapping a set of outputs from a corresponding first set of unintegrated analytics models in the plurality of unintegrated analytics models to a set of inputs of a second set of unintegrated analytics models in the plurality of unintegrated analytics models.

4. The method of claim 3, wherein mapping the set of outputs is based on stakeholder interactions.

5. The method of claim 3, wherein training the plurality of integrated analytics models further comprises:
using historical data to preliminarily train individual analytics models in the plurality of integrated analytics models; and
using the historical data and the individual analytics models to train the plurality of integrated analytics models to maximize a value function.

6. The method of claim 5, wherein the historical data comprises one or more of asset sensor data, asset event data, asset maintenance history, asset cost, remanufacturing costs, repair costs, historical key performance indicators (KPIs), historical buying decisions, or historical selling decisions.

7. The method of claim 1, wherein the plurality of integrated analytics models comprises two or more of a remaining-useful-life model, an asset-owner key performance indicator (KPI) estimation model, an asset recovery-process selection model, a remanufacturer KPI estimation model, a post remanufacture buyer KPI estimation model, an asset owner selling decision estimation model, a remanufacturer asset acceptance decision estimation model, or a post remanufacture buyer asset buying estimation model.

8. A computer-readable medium storing computer executable code for providing one or more recommendations regarding a disposition of one or more asset classes, the computer executable code comprising instructions for:
accessing information regarding a plurality of unintegrated analytics models for a value of assets in the one or more asset classes to a plurality of stakeholders;
training, using an integrated training methodology, a plurality of integrated analytics models to maximize the value of an asset in the one or more asset classes for the plurality of stakeholders; and
generating, for each of a set of stakeholders in the plurality of stakeholders, a recommendation regarding the disposition of a particular asset in the one or more asset classes based on the plurality of integrated analytics models trained to maximize the value of the particular asset.

9. The computer-readable medium of claim 8, wherein the recommendation regarding the disposition of the particular asset generated for a particular stakeholder in the set of stakeholders comprises at least one of a first recommendation to retain the particular asset, a second recommendation of a price at which to sell the particular asset, or a third recommendation for a recovery process for a recovery operator.

10. The computer-readable medium of claim 8, wherein training the plurality of integrated analytics models comprises:
mapping a set of outputs from a corresponding first set of unintegrated analytics models in the plurality of unintegrated analytics models to a set of inputs of a second set unintegrated analytics models in the plurality of unintegrated analytics models.

11. The computer-readable medium of claim 10, wherein mapping the set of outputs is based on stakeholder interactions.

12. The computer-readable medium of claim 10, wherein training the plurality of integrated analytics models further comprises:
using historical data to preliminarily train individual analytics models in the plurality of integrated analytics models; and
using the historical data and the individual analytics models to train the plurality of integrated analytics models to maximize a value function.

13. The computer-readable medium of claim 12, wherein the historical data comprises one or more of asset sensor data, asset event data, asset maintenance history, asset cost, remanufacturing costs, repair costs, historical key performance indicators (KPIs), historical buying decisions, or historical selling decisions.

14. The computer-readable medium of claim 8, wherein the plurality of integrated analytics models comprises two or more of a remaining-useful-life model, an asset-owner key performance indicator (KPI) estimation model, an asset recovery-process selection model, a remanufacturer KPI estimation model, a post remanufacture buyer KPI estimation model, an asset owner selling decision estimation model, a remanufacturer asset acceptance decision estimation model, or a post remanufacture buyer asset buying estimation model.

15. An apparatus for providing one or more recommendations regarding a disposition of one or more asset classes comprising:
a computer-readable medium storing computer executable code; and
at least one processor, that when executing the computer executable code, is configured to:
access information regarding a plurality of unintegrated analytics models for a value of assets in the one or more asset classes to a plurality of stakeholders;
train, using an integrated training methodology, a plurality of integrated analytics models to maximize the value of an asset in the one or more asset classes for the plurality of stakeholders; and
generate, for each of a set of stakeholders in the plurality of stakeholders, a recommendation regarding the disposition of a particular asset in the one or more asset classes based on the plurality of integrated analytics models trained to maximize the value of the particular asset.

16. The apparatus of claim 15, wherein the recommendation regarding the disposition of the particular asset generated for a particular stakeholder in the set of stakeholders comprises at least one of a first recommendation to retain the particular asset, a second recommendation of a price at which to sell the particular asset, or a third recommendation for a recovery process for a recovery operator.

17. The apparatus of claim 15, wherein the at least one processor is configured to train the plurality of integrated analytics models by being configured to:
use historical data to preliminarily train individual analytics models in the plurality of integrated analytics models;
map a set of outputs from a corresponding first set of unintegrated analytics models in the plurality of unintegrated analytics models to a set of inputs of a second set unintegrated analytics models in the plurality of unintegrated analytics models; and
use the historical data and the individual analytics models to train the plurality of integrated analytics models to maximize a value function.

18. The apparatus of claim 17, wherein mapping the set of outputs is based on stakeholder interactions.

19. The apparatus of claim 17, wherein the historical data comprises one or more of asset sensor data, asset event data, asset maintenance history, asset cost, remanufacturing costs, repair costs, historical key performance indicators (KPIs), historical buying decisions, or historical selling decisions.

20. The apparatus of claim 15, wherein the plurality of integrated analytics models comprises two or more of a remaining-useful-life model, an asset-owner key performance indicator (KPI) estimation model, an asset recovery-process selection model, a remanufacturer KPI estimation model, a post remanufacture buyer KPI estimation model, an asset owner selling decision estimation model, a remanufacturer asset acceptance decision estimation model, or a post remanufacture buyer asset buying estimation model.
